(19) United States
(12) Patent Application Publication
(10) Pub. No.: US 2003/0202837 A1
(43) Pub. Date: Oct. 30, 2003

(54) Kit with individual crayon shaped condiment containers

(75) Inventors: Marie K. Trifunovich, Gurnee, IL (US); Michael A. Trifunovich, Gurnee, IL (US); Lauren M. Trifunovich, Gurnee, IL (US)

Correspondence Address: MERONI + MERONI, P.O. BOX 309, BARRINGTON, IL, 60011, US

(73) Assignee: The Consulting House, Inc.

(21) Appl. No.: 10/135,476

(22) Filed: Apr. 30, 2002

(51) Int. Cl. A21D 10/02

(52) U.S. Cl. 401/150; 99/494

(57) ABSTRACT

A multiple food condiment dispensing kit comprising a plurality of tubular plastic containers for use as a marking instrument having a valve at a top end with a centrally located aperture and a flat bottom. Semi-rigidity of the walls enables each of the containers to stand upright on the bottom of the container and enables deflection of the walls under a predetermined amount of grip strength. Each of the containers contains a food condiment to be dispensed through the aperture and are colored to substantially match the color of the food condiment contained within the container. A label on an outer surface of each of the containers is colored to match the color of the condiment within the container. The containers are placed within a box to form a kit for applying food condiments to food. The box has an aperture through a wall to allow viewing of the contents.

### BACKGROUND OF THE INVENTION

1. Field of the Invention

The present invention generally relates to condiment containers. More specifically, the present invention relates to kits with individual condiment containers.

2. Description of the Prior Art

Parents of small children commonly have problems in getting their children to eat food that the parents have prepared for them. Over the years, people have developed several different approaches in dealing with this problem including developing entertaining themes, incorporating bright colors, and using interactive methods of preparing and consuming the food. However, as children become used to interacting with these types of approaches, new and more creative types of food related items are needed to retain the attention of young children so that they will be interested in eating the food that their parents have prepared for them.

One approach to the problem of getting children to eat food prepared for them is to allow the children to decorate their food with different types of food condiments before eating the food, such as children using ketchup to create a design on their sandwich. This allows the children to entertain themselves by augmenting the food preparation of their parents with decorative design created by the children. The interaction between the children and the food cause the children to be more likely to eat the food thus achieving the goal of getting the children to eat the food.

In an attempt to provide parents with different types of food condiments that would be entertaining for the children to use while decorating and consuming their food, different manufactures to date have made slight alterations to existing food condiment products that are slightly more entertaining for children. The following previously issued United States patents disclose several different types of food condiment containers and food condiment packaging that have been made previously.

U.S. Pat. No. 6,322,177 issued to Vasudeva, discloses a drop bin container for holding condiments or crayons. This patent refers to an invention that may be used for the storage of both condiment containers and crayons; however, this patent does not refer to a container that may be used to store a condiment in a crayon shaped container.

U.S. Pat. No. 6,085,949 issued to Zimmy et al., discloses a Container with Molded-In Directional Pour Guide. This invention discloses a container for condiments with a shaped pour guide for controlling and directing the flow of liquids out of the container.

U.S. Pat. No. 5,868,323 issued to Cantor, discloses a Dispensing Orifice for Liquid Contents. This device is used for liquid condiments for a dropwise dispensing pattern or a streamwise dispensing pattern. This device is placed on a bottle or flask in which the condiment is dispensed by tilting the contents thus enabling better control of the content flow as it exits the bottle. The invention does not disclose a device to enable the user to make designs on food with the condiment.

U.S. Pat. No. 5,601,212 issued to Lee, discloses a Dispensing Unit for a Threaded Neck Bottle. This invention comprises a condiment supply container, a squeezable dispensing nipple, and a connector connecting the container and nipple. The invention relates to an improved dispensing means for a more efficient form of applying a condiment but not one that allows the degree of control necessary to draw or illustrate with a condiment. Furthermore, the surface is not sized to be easily configured for physical handling.

U.S. Pat. No. 5,244,268 issued to Derrickson discloses a Carrying Case for Food Items. This product is a portable carrying case with slotted compartments for transportation of condiments.

U.S. Pat. No. 4,944,435 issued to Lee, discloses a disposable condiment dispenser. The device is made from cylindrical cardboard tube with the lower end of the cylinder upturned and the upper end closed with a perforated disk fitted into the cylinder.

There are containers disclosed within the prior art that intend to be single service containers such as those where a condiment is in a small plastic package. When a customer needs mustard, for example, he/she tears off a corner of one of those packages, squeezes the product out, and disposes of the container. Other products have attempted the convenience of single service packaging of condiments without the inconvenience of tearing open a plastic pouch. U.S. Pat. No. 4,809,852 issued to Mancini is one such product. Mancini discloses a disposable container that retains liquids in two opposed container sections formed in a thermoforming operation. The Mancini patent is not formed in a shape that is may be easily manipulate by a child or artist attempting to proceed to draw with the applicator.

United States patents have also been granted for nozzles and container that may be squeezed to apply viscous materials other than condiments. These patents do not anticipate gripping a condiment container in a fashion such as when drawing with a crayon.

U.S. Pat. No. 5,388,925 issued to Wilcox et al., discloses a Fine Point Tip Applicator For Craft Paint, discloses a fine applicator tip for a craft paint. This patent does not consider the use of a squeezable container to apply a condiment upon a food item.

U.S. Pat. No. 4,693,205 issued to Lee, discloses a egg decorating kit that in addition to a support structure for the eggs includes a collapsible fluid container that contains a decorative fluid for application to the egg. However, the kit does not consider decorating food stuffs with condiments contained in a disposable container.

With the foregoing in mind, there still remains a need for a kit that conveniently provides a plurality of different types of food condiments individually packaged in disposable containers having structure that allows a user of the condiment containers to apply the condiments in a decorative fashion to food.

### SUMMARY OF THE INVENTION

To provide a solution to the aforementioned need, the claimed invention provides a multiple food condiment dispensing kit for applying food condiments to food.

An objective of the claimed invention is to provide a kit having more than one type of food condiment for use in applying the food condiments to food.

Another objective of the claimed invention is to provide a kit having disposable condiment containers that have structure to allow finely directed flow of the condiment within the condiment container so that a person using the condiment container can create designs with the food condiment as it is dispensed.

A further objective of the claimed invention is to provide a kit that increases the likelihood of young children eating food prepared for them by their parents.

To achieve the foregoing objectives, and others that will become clear in the detailed description of the invention, a multiple food condiment dispensing kit for applying condiments to food is provided. The kit comprises a plurality of semi-rigid wall tubular shaped plastic containers sized and shaped for use as a marking instrument. Each of the containers has a manually operated valve portion at a top end and a substantially flat bottom end. The valve portion tapers to a tip with a centrally located aperture. The semi-rigidity of the walls enable each of the containers to independently stand upright on the bottom end of the container. The semi-rigidity also enables deflection of the walls under a predetermined amount of grip strength. Each of the containers contain a food condiment to be dispensed through the centrally located aperture and colored to substantially match the color of the food condiment contained within the container.

Each container has a label on an outer surface colored to substantially match the color of the condiment within the container designating the type of food condiment stored within the container.

The containers are placed within a box sized and shaped to receive the containers to form a kit for applying the food condiments to food. The box has an aperture through a wall of the box to provide unobstructed viewing of the labels on the outside of the containers.

### BRIEF DESCRIPTION OF THE DRAWINGS

FIG. 1. FIG. 1 shows a preferred embodiment of the food condiment kit.

FIG. 2. FIG. 2 shows one of the food condiment containers.

FIG. 3. FIG. 3 shows how one of the food condiment containers is used.

FIG. 4. FIG. 4 shows an alternate embodiment of the invention where the food containers are connected by perforation structures.

FIG. 5. FIG. 5 shows the alternate embodiment shown on FIG. 4 where some of the food condiment containers are made of colored plastic matching the color of the food condiment contained within the condiment container.

FIG. 6. FIG. 6 shows another rendition of the kit.

FIG. 7. FIG. 7 shows the food condiment containers made of colored plastic matching the color of the food condiment contained within the condiment container.

### DETAILED DESCRIPTION OF THE PREFERRED EMBODIMENT

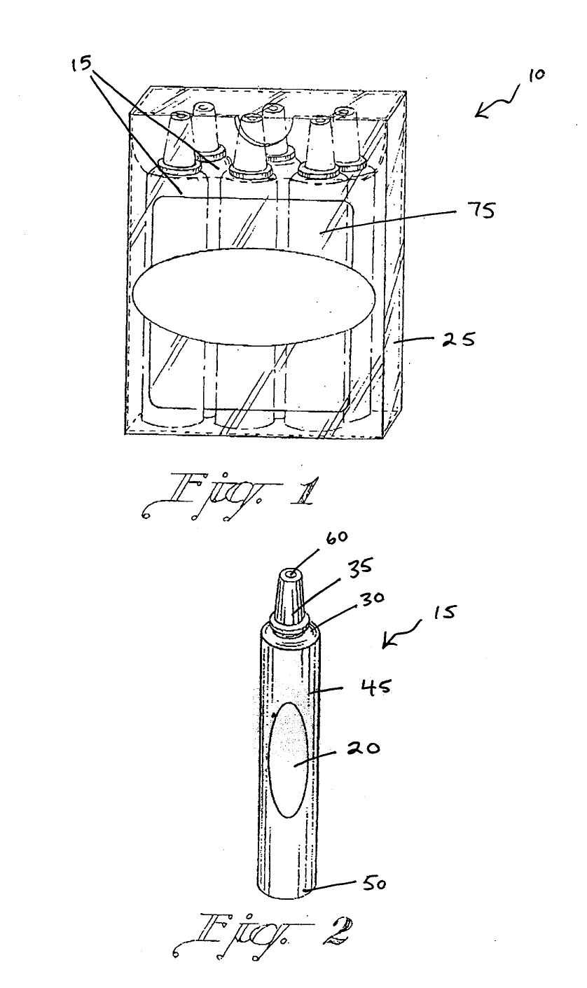

Turning now to the drawings, FIGS. 1-3 and 6 show a preferred embodiment of the kit 10. The kit 10 generally consists of a plurality of individual disposable containers 15 having a label 20 on an outer surface of each of the containers 15 and a box 25 for packaging the containers 15.

FIG. 1 shows the kit 10 having six containers 15 shaped substantially similar to crayons where the cone shaped top end 30 of each of the containers have a manually operated valve 35 for dispensing a food condiment 40 that is stored within each of the containers 15. It is contemplated that the kit 10 will consist of several of these crayon shaped containers 15 containing various different types of food condiments such as, but not limited to, ketchup, mustard, mayonnaise, pickle relish, peanut butter, butter, various types of jellies and preserves, barbecue sauce, hot sauce, and apple sauce.

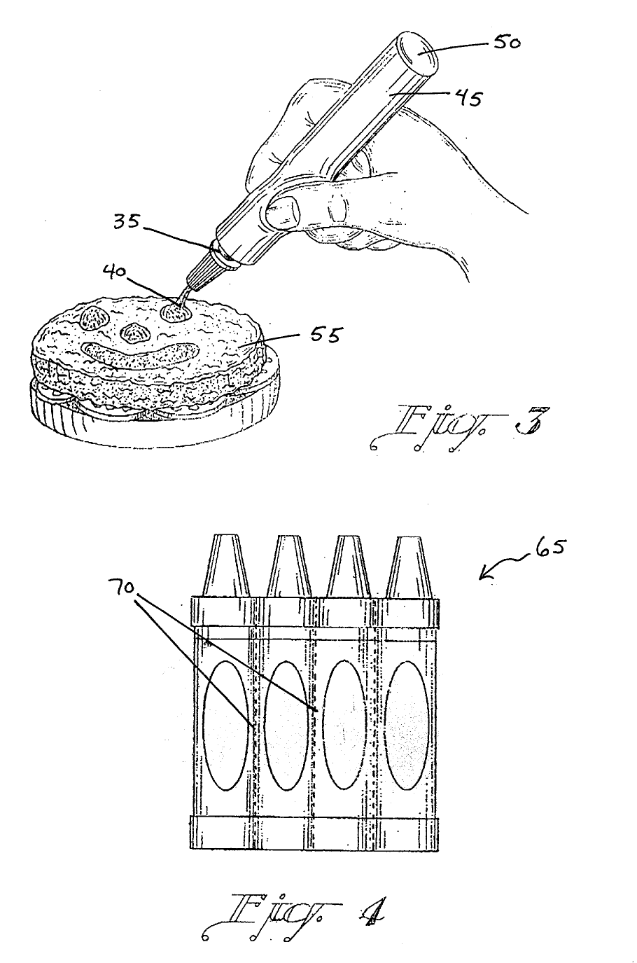

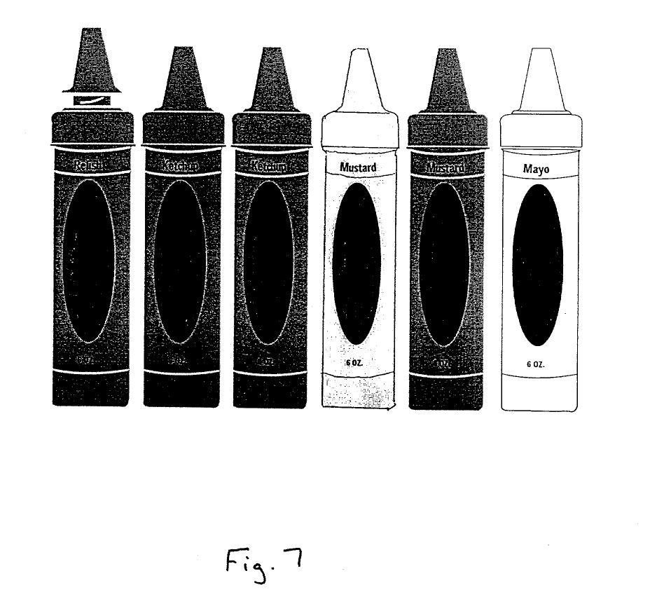

FIGS. 2 and 7 show individual condiment containers 15 used in the kit 10. Each of the condiment containers 15 have a tubular shaped body 45 made of a semi-rigid plastic that allows each of the condiment containers 15 to independently stand upright upon the flat bottom end 50 of the condiment container 15, yet is pliable such that the walls of the condiment container 15 can be deflected to aid in dispensing the condiment 40 from the condiment container 15. The condiment containers 15 shown in FIGS. 1 and 2 are made of a opaque, colored plastic and are about 6 inches long and have a diameter of about ¾ inch. The manually operated valve portion 35 as shown in FIGS. 2 and 7 are 0.85 inches in height. The size of this particular embodiment of the invention is such that more than one average size serving of the condiment can be contained within the container 15. However, it is contemplated that condiment containers 15 of different sizes will be used for different applications. Further, the shape and appearance of each of the condiment containers 15 are created to resemble a crayon. The

The color of plastic that each of the condiment containers 15 is made from will coincide with the general color of the condiment 40 being stored in the condiment container 15 such as a condiment container 15 containing ketchup being made of red plastic, and a condiment container 15 containing pickle relish being made of green plastic. However, it is also contemplated as being within the scope of the claimed invention that the condiment containers 15 could be made of transparent plastic so that the color of the condiment 40 within each of the condiment containers 15 could be viewed from outside of the condiment containers 15.

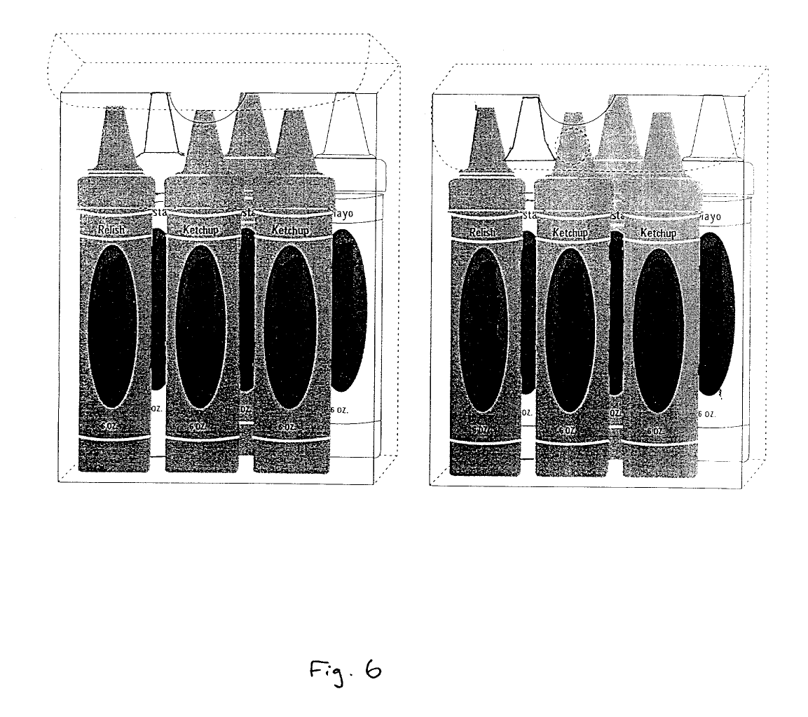

Each of the condiment containers 15 have a label 20 that can be displayed along the long axis of the condiment container 15 as shown in FIG. 2, or may be arranged horizontally as shown in FIGS. 5-7.

Providing a kit 10 such as the one shown in FIG. 1 having a plurality of different types of food condiments with crayon shaped containers colored to match the color of the condiments 40 creates a kit 10 that resembles a box of crayons. The presentation of food condiments in this manner creates an attractive way of packaging food condiments for young children. Young children commonly use crayons for drawing pictures and coloring in coloring books. The claimed invention provides a kit 10 that presents food condiments in a crayon like manner that would attract children into using the food condiments on their food to create designs with the food condiment, thus making the children more likely to eat the food that they have decorated.

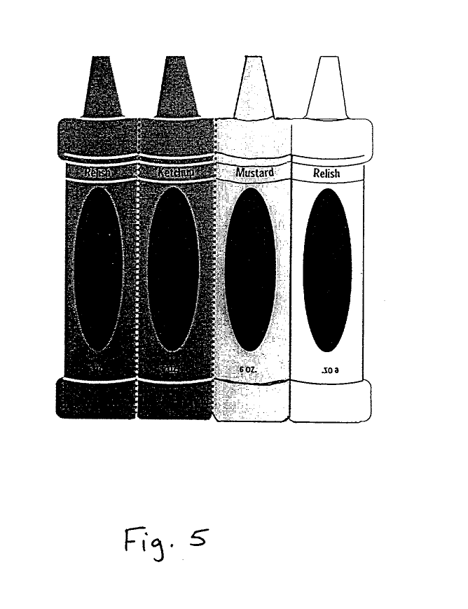

FIG. 3 shows how each of the condiment containers 15 are used. Being as each of the condiment containers 15 are crayon shaped, a person using the condiment container 15 can hold the condiment container 15 in a manner similar to the way the person would hold a crayon. The person using the condiment container 15 would first open the manually operated valve so that it would resemble the container shown in FIG. 2 and then apply the food condiment 40 to food 55 by squeezing the contents of the container 15 onto the food 55. The cone shaped top portion 30 of each of the condiment containers 15 terminates into a centrally located aperture 60 where the condiment 40 flows from the container 15 onto the food 55. The relatively small size of the aperture 60 allows a user of the condiment container 15 to direct the flow of the food condiment 40 in a desired pattern. This allows young children using the condiment containers 15 to simulate drawing on their food with a crayon shaped condiment container 15 as they would draw with a real crayon on a piece of paper.

Allowing children to decorate their food provides them with entertainment and makes them more likely to eat the food that they have decorated. The claimed invention provides a convenient, colorful, and interesting kit 10 that has a plurality of different food condiments all within one box.

The box 25 as shown in FIG. 1 is sized and shaped to hold a plurality of condiment containers 15. The box 25 of FIG. 1 holds six of the condiment containers 15, but it is within the scope of the invention that different sizes and shapes of boxes 25 can be created to hold a varying number of condiment containers 15 of varying size and shape. The preferred embodiment of FIG. 1 also has an opening 75 on one side of the box 25 to allow the contents of the box 25 to be viewed from outside of the box 25.

FIG. 4 shows an alternative embodiment of the claimed invention. In this embodiment of the claimed invention, the condiment containers 65 are preferably molded together out of transparent plastic, connected by a perforated strip 70 in between each of the condiment containers 65. This presentation of the claimed invention is contemplated as being used in situations where the condiment containers 65 would be used individually instead of as a part of an overall kit 10 such as in institutional or commercial uses. Further, FIG. 5 shows the alternative embodiment where each of the condiment containers 65 are made of colored plastic matching the general color of the condiment contained within the condiment containers 65. Preferably, the condiment containers as shown in this alternative embodiment are 4 inches in height including the ½ inch manually operated valve and are ½ inch in diameter.

Although the invention has been described by reference to some embodiments it is not intended that the novel device be limited thereby, but that modifications thereof are intended to be included as falling within the broad scope and spirit of the foregoing disclosure, the following claims and the appended drawings.

I claim:

1. A multiple food condiment dispensing kit for applying food condiments to food, the kit comprising:
a plurality of semi-rigid wall tubular shaped plastic containers sized and shaped for use as a marking instrument having a manually operated valve portion at a top end and a substantially flat bottom end, the valve portion tapering to a tip with a centrally located aperture, the semi-rigidity of the walls enabling each of the containers to independently stand upright on the bottom end of the container and enabling deflection of the walls under a predetermined amount of grip strength, each of the containers containing a food condiment to be dispensed through the centrally located aperture and colored to substantially match the color of the food condiment contained within the container;
a label on an outer surface of each of the containers colored to substantially match the color of the condiment within the container; and
a box sized and shaped to receive the containers, the containers being placed within the box to form a kit for applying the food condiments to food, the box having an aperture through a wall of the box to provide unobstructed viewing of contents of the box.

2. The kit of claim 1 wherein each of the containers are about 2 inches to about 8 inches in length and are about ½ inch to about 2½ inches in diameter.

3. The kit of claim 2 wherein at least three different condiments are contained within the kit.

4. The kit of claim 3 wherein one of the containers contains ketchup, one of the containers contains mustard, one of the containers contains mayonnaise, and one of the containers contains pickle relish.

5. The kit of claim 2 wherein one of the containers contains peanut butter and one of the containers contains jelly.

6. The kit of claim 2 wherein one of the containers contains barbecue sauce.

7. The kit of claim 2 wherein one of the containers contains butter.

8. A multiple food condiment dispensing kit for applying food condiments to food, the kit comprising:
a plurality of semi-rigid wall tubular shaped plastic containers sized and shaped for use as a marking instrument having a manually operated valve portion within a top end of each container and a substantially flat bottom end, the semi-rigidity of the walls enabling each of the containers to independently stand upright on the bottom end of the container and enabling deflection of the walls under a predetermined amount of grip strength, each of the containers containing a food condiment, at least two of the plurality of containers containing dissimilar food condiments; and
a box sized and shaped to receive the containers, the containers being placed within the box to form a kit for applying the food condiments to food.

9. The kit of claim 8 wherein the valve portion tapers to a tip with a centrally located aperture for dispensing the food condiment.

10. The kit of claim 9 wherein each of the containers are about 2 inches to about 8 inches in length and are about ½ inch to about 2½ inches in diameter.

11. The kit of claim 10 wherein the containers are transparent so that the food condiments within each of the plurality of containers may be viewed through the transparent walls of the containers.

12. The kit of claim 11 wherein each of the containers has a label on an outer surface of the container colored to substantially match the color of the condiment within the container.

13. The kit of claim 12 further comprising an aperture through a wall of the box to provide unobstructed viewing of the condiments within each of the plurality of containers through the transparent walls of the containers.

14. The kit of claim 13 wherein one of the containers contains ketchup, one of the containers contains mustard, one of the containers contains mayonnaise, and one of the containers contains pickle relish.

15. A food condiment dispensing kit for applying food condiments to food, the kit comprising:
a plurality of semi-rigid wall tubular shaped plastic containers sized and shaped for use as a marking instrument having a manually operated valve portion at a top end and a substantially flat bottom end, the valve portion tapering to a tip with a centrally located aperture, the semi-rigidity of the walls enabling each of the containers to independently stand upright on the bottom end of the container and enabling deflection of the walls under a predetermined amount of grip strength, each of the containers containing a food condiment to be dispensed through the centrally located aperture; and
a perforated joining structure joining the plurality of containers together formed as a contiguous part of the container wall, the perforation enabling separation of a container from the plurality of containers.

16. The kit of claim 15 wherein the container walls are transparent so that the food condiment within each of the plurality of containers may be viewed through the transparent walls of the containers.

17. The kit of claim 16 wherein each of the containers are about 2 inches to about 8 inches in length and are about ½ inch to about 2½ inches in diameter.

18. The kit of claim 17 wherein at least two of the plurality of containers contain dissimilar food condiments.

19. The kit of claim 18 wherein each of the containers has a label on an outer surface of the container colored to substantially match the color of the condiment within the container.

20. The kit of claim 19 wherein one of the containers contains ketchup, one of the containers contains mustard, one of the containers contains mayonnaise, and one of the containers contains pickle relish.
